(19) United States
(12) Patent Application Publication
(10) Pub. No.: US 2026/0042077 A1
(43) Pub. Date: Feb. 12, 2026

(54) PROTON-RICH IONIC FLUID SYSTEMS AND METHODS

(71) Applicant: TegIPco, LLC, Dover, DE (US)

(72) Inventors: Nicholas Joseph Wilson Arvanitakis, Cochise, AZ (US); Chrisanthos Arvanitakis, Cochise, AZ (US)

(73) Assignee: TegIPco, LLC, Dover, DE (US)

(21) Appl. No.: 19/252,231

(22) Filed: Jun. 27, 2025

Related U.S. Application Data
(60) Provisional application No. 63/680,865, filed on Aug. 8, 2024.

(51) Int. Cl. B01J 19/08; C01C 1/02; C10G 7/00; E21B 43/16

(52) U.S. Cl. CPC B01J 19/087; C01C 1/026; C10G 7/00; E21B 43/16; B01J 2219/085; B01J 2219/0877

(57) ABSTRACT

A system and method for converting a common hydrogen-based input fluid into an proton-rich ionic fluid (PRIF) comprising an overabundance of hydrogen H₁+ protons is disclosed. This conversion occurs in the absence of elevated temperatures or pressures, so that the resulting output fluid is suitable for shipping or storage at Standard Temperature and Pressure (STP). Some practical usages for the PRIF include 1) AMMONIA MANUFACTURING WITHOUT HABER-BOSCH; 2) CRUDE OIL IMPROVEMENT (API LIFT); 3) MOLECULAR ENHANCEMENT OF HYDROCARBON; and 4) DESULFURIZATION (distillate upgrade).

### FIELD OF THE INVENTION

The embodiments herein relate to fuel production, storage, and transport through the concentration and extraction of hydrogen derived from common hydrogen-bearing liquids.

### BACKGROUND OF THE INVENTION

There exist a variety of different processes to make hydrogen, many of which are the subject of significant research and development efforts. Some of the processes disclosed include biomass pyrolysis or gasification and biological processes, such as bacterial fermentation and enzymatic hydrogen production. Electrolysis is another technology for making hydrogen in which water is decomposed into oxygen and hydrogen. Currently, however, hydrogen is produced commercially from fossil methane. Such production processes are inexpensive and the natural gas feedstock for the process is widely available and relatively low cost.

Some of the attempts to isolate hydrogen suffer from numerous impediments and inefficiencies that make them sub-optimal for capture and transport of hydrogen in a usable non-dangerous form. Isolating hydrogen can consume a lot of energy, can give of CO₂, and many other disadvantages. Consequently, an improved system for capturing hydrogen is desired.

### SUMMARY OF THE INVENTION

The embodiments herein are directed to creating a stable, solubilized PRIF bearing atomic hydrogen at standard temperatures and pressures for use in power, storage and transportation. A wide variety of common input liquids may be used as feedstock for the system and method so long as they are rich in constituent hydrogen. The processes require application of low cost electrostatic and magnetostatic forces that aid in increasing a saturation of protons predominantly atomic hydrogen and a decrease of overall electric charge throughout the fluid. No catalysts or imposed change to the state of the starting fluid is required during the process of the invention.

Advantageously, a saturation of protons will be obtained and a deficiency of electrons by batch or continuous process flow that may be measured and verified experimentally by specific gravity, pH, resistivity and conductivity, thus insuring that an output liquid product is proton rich and electron depleted. In one embodiment, a system, apparatus, and method for concentrating hydrogen in a liquid is disclosed.

A method for driving an overabundance of hydrogen in a liquid is provided in which a liquid is placed in a static electric field having a first polarity. The liquid is then moved through a static magnetic field having a first polarity, through a static electric field having a second polarity, through a static magnetic field having a second polarity, and then through an oscillating magnetic field.

Finally, this entire disclosure strives to show practical usages, applications, and potential end customers for the various embodiments herein, where possible.

### BRIEF DESCRIPTION OF DRAWINGS

The various embodiments of the inventive subject matter of the present disclosure will be described in more detail in conjunction with the following figures. The structures in the figures are illustrated schematically, and they are not necessarily drawn to scale. The figures are not intended to show actual dimensions.

FIGS. 1A and 1B show non-limiting arrangements of reactor systems for producing a Proton-Rich lonic Fluid (PRIF) according to the embodiments herein;

FIGS. 2, 3A, and 3B show example methods of operation of the reactor systems of FIGS. 1A and 1B;

FIGS. 4A, 4B, 4C, 5A, 5B, 5C, 5D, 6A, 6B, and 6C show detail of one or more recirculators;

FIGS. 7A-7B-7C show contrasting arrangements of alternate embodiments of reactor the systems;

FIG. 7D shows a recirculator using information from a testing module;

FIGS. 8A, 8B, and 8C show flowcharts of potential practical usages of the PRIF;

FIG. 9 shows an example Prior Art method of producing ammonia using the PRIF;

FIGS. 10 and 11 show a flowchart and equipment for assessing API lift;

FIG. 12A shows an example Prior Art apparatus and flowchart for achieving a distillate upgrade, intentionally simplified for clarity;

FIG. 12B shows the embodiment of FIG. 12A but modified to show potential injection-points for introducing PRIF therein;

FIG. 13 shows an example apparatus and flowchart for achieving de-sulphurization, intentionally simplified for clarity; and

FIG. 14 shows some aspects of using the PRIF for manufacturing ammonia.

### DETAILED DESCRIPTION OF THE PREFERRED EMBODIMENTS

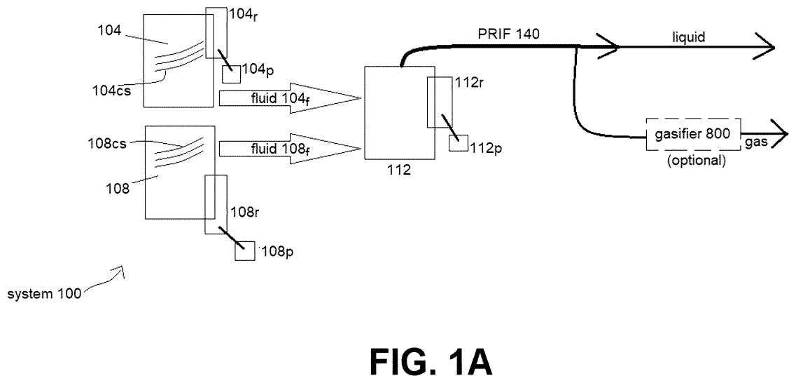

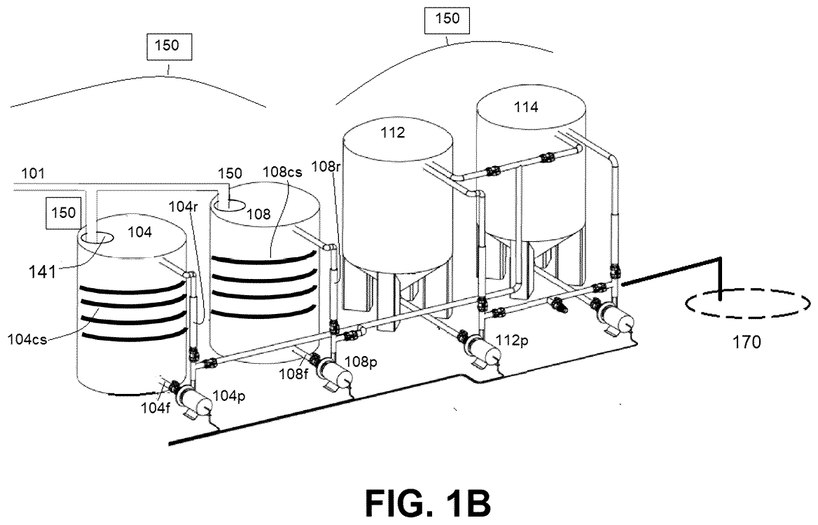

FIG. 1A shows an example system 100 for producing a Proton-Rich lonic Fluid (PRIF) 140. The system 100 converts a common hydrogen-based input fluid 101 to the PRIF 140 comprising an overabundance of hydrogen H₁+ atoms, mainly just protons since atomic hydrogen does not have a neutron and the electron has been peeled off. This conversion occurs in the absence of elevated temperatures or pressures, so that the resulting PRIF 140 is suitable for shipping or storage at Standard Temperature and Pressure (STP, AKA Normal Temperature and Pressure NTP). One example period of reliable shelf-life of the PRIF 140 might be 36 months, although there could be examples of even longer shelf-life, depending on the specific formulation.

The input fluid 101 may be one of various commonly-found hydrogen-donating fluids or mixes of multiple hydrogen-donating fluids, and can also be dirty water, fracked water, and/or processed water. A non-limiting list of potential types of hydrogen-donating fluids can be found in an Appendix A to this disclosure, titled “EXAMPLE HYDROGEN-DONATING INPUT FLUIDS 101”.

Referring to FIGS. 1A and 1B, an example system 100 and flowchart includes a first tank 104, a second tank 108, a third tank 112, and corresponding recirculators 104r, 108r, 112r. Both first and second tanks 104\108 comprise recirculator 104r\108r, pump104p\108p, and windings or inductor coils 104cs\108cs. Both first and second tanks also pump out intermediate fluids 104f\108f that has been partially-processed and is on its way to becoming the proton rich ionic fluid (PRIF) 140. FIG. 1B shows a fourth tank 114 which acts as a potential overflow tank, or storage tank, or other way of assisting in management of PRIF 140 during or after a production run thereof. In the flowcharts of FIGS. 1A-1B, all activity flows from left to right.

The tanks 104\108 have the circumferential windings 104cs\108cs applied to their outer surface thereby forming a reaction zone. The windings 104cs\108cs can be formed with stranded wire or other types of windings to act as a large-scale inductor coil. FIG. 1B also shows a seal 141 on the tank, and a detector 150. The tanks 104/108/112 can be operated at NTP/STP, but for detecting various gaseous components, the seal 141 could be helpful in trapping and capturing. The detector 150 can capture a lot of different components, as will be discussed in more detail herein.

The circumferential windings or inductor coils 104cs\108cs may be electrically coupled to a power supply so as to be electrically coupled to either alternating or direct current at a variety of frequencies. An amount of insulation on the wires and tanks, spacing between specific windings, and wire gauge all may vary according to a desired outcome.

The pumps 104p\108p are coupled to the recirculators 104r\108r which have magnetic modules 508 in various orientations attached thereto. However, the magnetic modules 508 can come in a lot of widely differing formats, of which the embodiments shown in the various FIGS herein are but non-limiting examples.

The activity within the reactor system(s) 100 result in removing electrons from the input fluid in such a way that the resulting PRIF becomes electron-deficient. This PRIF 140 can remain electron deficient at STP for varying periods, e.g. having a shelf-life of 36 months. The circumferential windings 104cs\108cs can have a variety of voltages and currents applied thereto. The voltage applied to the windings 104cs may be equal to that applied to the windings 108cs, or may not. Further, a voltage may be applied to one set of windings but not the other, and polarity may be altered.

A pre-determined wattage for the circumferential windings 104cs\108cs can be selected based on the chemical constituents of the input fluid 101, a desired configuration of the PRIF 140, ambient temperature, volume of end-product, and other factors. As current moves through windings 104cs\108cs, a corresponding magnetic field directed perpendicularly to windings 104cs\108cs applies a magnetostatic force to liquid 101 while being circulated through the tanks 104\108 for a predetermined period of time until the outlet fluid 104f\108f is transferred via e.g. to the 3^{rd} tank 112.

The magnetostatic forces applied to the windings 104cs\108cs can be adjusted between 2,000-80,000 Gauss, with 20,000-80,000 Gauss being a preferred range. When outlet openings 104f and 108f are opened, the fluids 104f\108f are combined into the third tank 112 which comprises a recirculator 112r and pump 112p. Once the fluid from both first tank 104 and second tank 108 are combined into the third tank 112, the combination is pumped and recirculated within the third tank 112.

Unlike the first tank 104 or second tank 108, third tank 112 does not have a circumferential windings, and therefore experiences no electrostatic effects. Instead, the third tank 112 experiences an oscillating magnetic field through the recirculator 112r due to the magnetic-modules 508 attached thereto.

During operation of the system 100, some oxygen vapes off, and goes away in a variety of forms. This is due to the fact that one purpose of the system 100 is to break the covalent bonds of a water molecule, separate out the oxygen\electrons and drive them off (prevent them from re-combining), and thus isolate protons in the form of H₁+. One reason this can be done at low power is because a typical water molecule is known to be a weak dipole, where some of the H can be separated from the O just by mechanical forces, some of which occur within the recirculators 104r /108r /112r.

The sensors 150 are used to affirm proper performance of the system 100, including temperature. In tank 104 there may be a slight exotherm 20-30 degrees F. based on which proton donor was used within the input fluid 101. Content of the specific chosen input fluid 101 can affect this, due to clean water v. dirty water v. produced water or other type of effluent source (see Appendix A).

Oxygen may gas off maybe 2-3% in overall mass difference, perhaps in the format of O2 but also in other formats. Various oxygen radicals are formed during production-use of the system 100, mostly oxygen based salts, which can vary according to a wide variety of conditions including but not limited to the content of the input fluid 101. These salts end up getting excreted through the back-end portion 170 of the system 100.

In a lower-cost embodiment, the detector 150 can be focused mainly on CO2 and O2, which both have special significance in hydrogen generation. However, the detector 150 can have wider scope, depending on manufacturing considerations and end-customer preferences.

If the input fluid 101 contains sulfuric acid, that can lead to sulfate salts, colloidal sulfur, and/or sulfur dioxide. Meanwhile, produced water tends to result in carbonates, oxides, and chloride salts. Acetic acid can lead to acetate salts.

The semicircle 170 represents a combination of filters, precipitate catch mechanisms, and or hydrocyclone, which may catch any of the below. That is, a non-limiting list of specific oxygen radicals and salts (either gas or solid) given off during use of the system 100 can include but are not limited to:
hydroxide salts (_OH); carbonate salts (_CO3);
sulfate salts (_SO4); nitric salts (_NO3);
dioxides (_O2), the most of important of which is CO2;
acetates (_CH3COO-); and alkoxides (_COH alcohol salts).

The proton-donating input fluid 101 (Appendix A) can comprise many different blends and even different waters and oils thus any of these will have different sludges and precipitates.

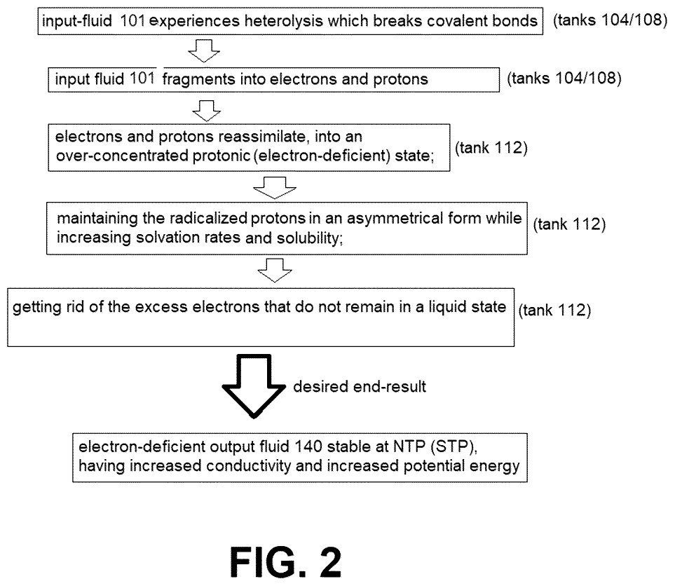

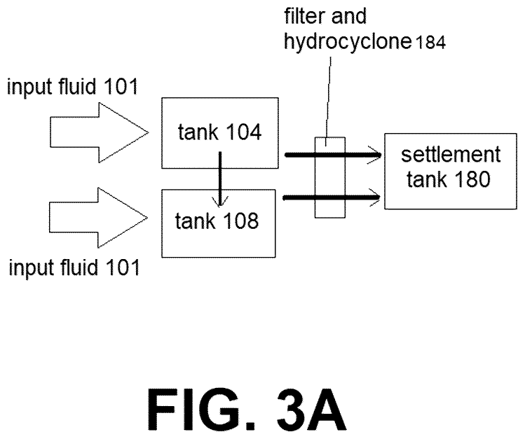

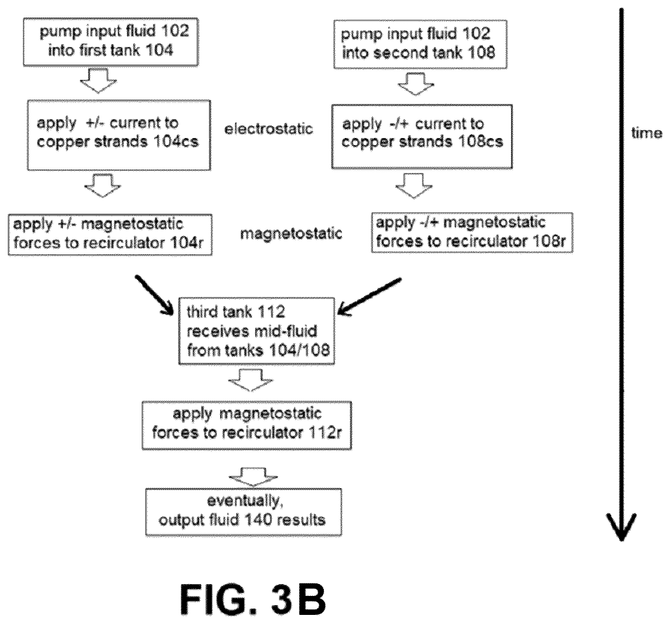

FIGS. 2 and 3A-3B show example methods of operation of the reactor systems of FIGS. 1A and 1B. Regarding the flowchart of FIG. 3A, in an embodiment, the second tank 108 might have twice the capacity of the first tank 104. An example operation of the flowchart of FIG. 3A might be where the tanks 104/108 are filled up with the input fluid 101 in equal proportions, and processed separately. The recirculators 104r/108r (not shown in FIG. 3A) could be set to opposite polarities. Then, the contents of tank 104 could be put into second tank 108 for further processing for predetermined time periods.

The second tank 108 might have the following elements added which may not be in the first tank 104: flocculants, polyacrylamides, ferric sulfates, and/or gypsum. An additional variation might be to add alcohol to the input of the first tank 104.

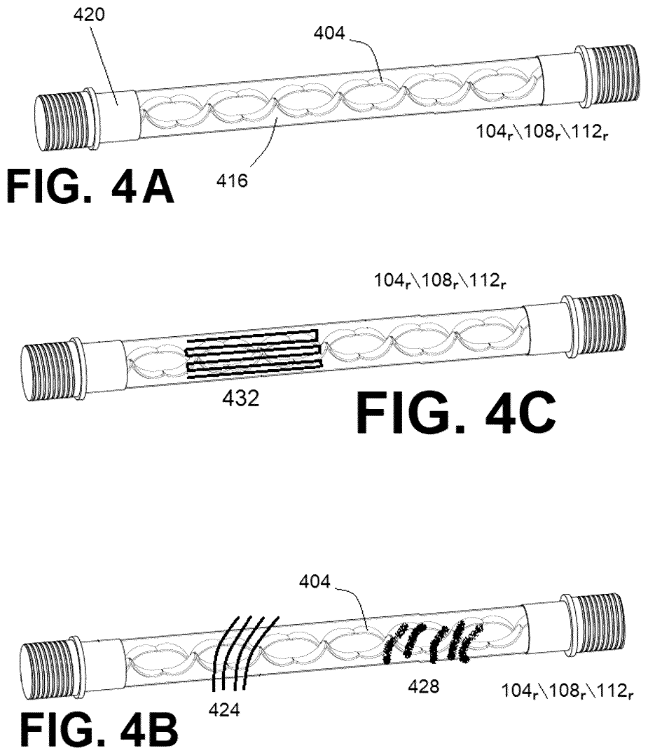

FIGS. 4A, 4B, 4C, 5A, 5B, 5C, 5D, 6A, 6B, and 6C show detail of the recirculators 104r, 108r, and 112r, which are sometimes referred to as static mixers. As shown at least within FIGS. 4A-4C, each recirculator can be formed as an elongated translucent tube that has movable internal fluting 404 (AKA baffle) located therein. The recirculators 104r, 108r, and 112r further comprise a grommet 420 at each end, along with threaded surfaces so that they may be connected in series. The internal fluting 404 aids in restraining fluid flowing through the tubes 416 thereby forming a type of reaction zone in which covalent bonds can be broken, and heterolysis can occur (FIG. 2). Each internal fluting 404 can be formed with a plurality of grommets 420 that can be concatenated to one another so as to form a chain structure if desired. The fluting 404 is important because it can break or at least strain the covalent bonds holding water together. It is an advantage of the embodiments herein to break the covalent bonds of the water with as little energy as possible. The fluting 404 leverages the fact that a water molecule has a weak dipole, a weak covalent bond.

FIG. 4B shows example windings 424 and inductor coils 428 embedded within the plexiglass body (tube 416) of a recirculator. These coils 428 are configurable at a variety of polarities and electromagnetic capabilities. FIG. 4C shows another example of inductor- patterning, where an inductive mechanism 432 is configured in a “rear window defogger” serpentine configuration.

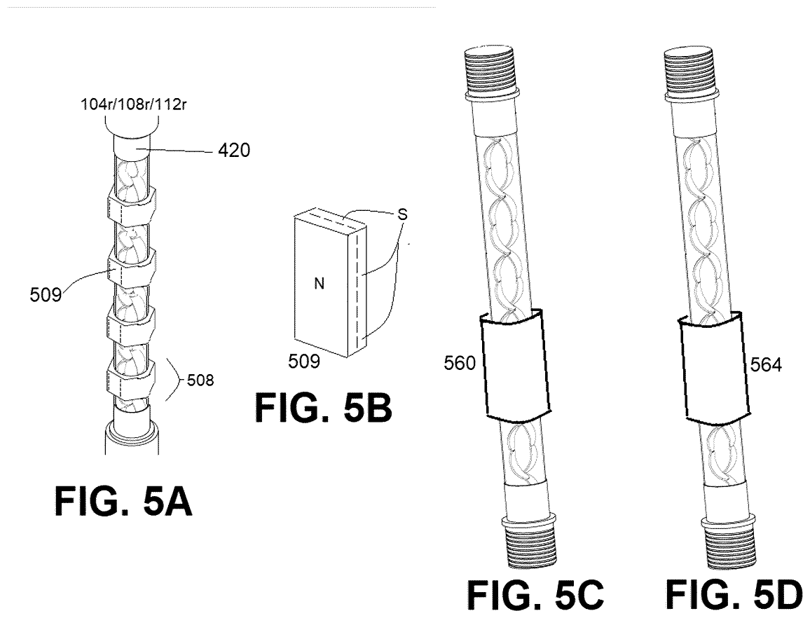

FIG. 5A shows an example recirculator with magnets 509 taped on. FIG. 5B shows an example of rectangular magnet 509 that is polarized in a way different than a domino magnet. FIG. 5C shows a recirculator with a slidable adjustable mechanical magnet-cuff 460. FIG. 5D shows a recirculator with a slidable adjustable electrical inductor-cuff 460.

The system 100 is designed to work in a variety of locations and climates, and with widely varying quality of water including unknown salinity, unknown metal content, unknown viscosity, and unknown level of pollutants. Accordingly, the magnetic modules 508 would be tunable and subject to continual adjustment. The system 100 may be used in remote areas where spare parts may be inaccessible, and may receive what small amounts of power it needs, from solar devices or off-grid devices that have varying levels of reliability. Accordingly, the magnetic modules 508 will have a lot of flexibility and adjustability, both mechanically and also electronically.

Moving to FIG. 5A, within any particular recirculator, the plurality of magnetic modules 508 are arranged circumferentially about the outer surface of the tube 416 and periodically located its length. In some embodiments, a magnet pack 508 is formed with one or more static bar-magnets 509 that define opposite polarities often denoted as a North and South.

The magnetic modules 508 are arranged on an outer surface of the tube 416 in specific ways. One example arrangement is where each North pole side may be facing e.g. radially inwardly, toward the center of tube 416. In this arrangement, each South pole side of a magnet or magnet group 509 would then face radially outwardly from an outer surface of the tube 416. The specific size, shape, and orientation of the individual magnets 509 can vary. FIG. 5B shows an example magnet 509 having a non-domino shape, but that is for example only.

As shown in FIG. 2, in operation, input fluid 101 is piped into tanks 104\108 until at least partially filled. The tanks 104\108 will have a predetermined wattages applied through their respective windings 104cs\108cs for predetermined time periods, often at least 45 minutes. Often, current applied through the circumferential windings 104cs \108cs may be between 5-100 amps at a wattage between 60-1200 watts, with 100 amps at 1,000 watts being advantageous. FIG. 3B shows another way of interpreting the flow within the system 100

During use, the recirculating pumps 104p\108p move the input fluid 101 through the tanks 104\108 via the recirculators 104r\108r. These in turn apply a uniform static magnetic field to input liquid 101 via the magnets 508.

A polarity applied to the recirculator 104r may be opposite the polarity applied recirculator 108r. In one embodiment, the recirculator 104r will be set with North pole sides 193 facing radially inwardly applying a total of 46,000 Gauss to input liquid 101, while the recirculator 108r will be set with South pole sides facing radially inwardly thereby applying a total of 46,000-58,000 Gauss to the input liquid 101.

Continuing this example, constant recirculation of the input fluid 101 from the tanks 104\108 through recirculators 104r\108r causes a non-transitory polar imbalance in the input liquid 101 resulting from breaking the weak dipole known to be present in water. The differences in fluid velocities within recirculators 104r\108r thus creates a separation and segregation of atomic hydrogen H₁+ within the input fluid 101.

The reactor system(s) 100 can be operated with a variety of ranges and thus have a lot of configurability and ability to be customized for specific types of production runs of the PRIF 140, and also can be adapted to specific types of input fluid 101. As stated, typically, the input fluid 101 will be a hydrogen-donating fluid such as shown in Appendix A. Further, each of the first, second, and third recirculators 104r\108r\112r can separately apply a pre-configured magnetic field to the fluid circulating therein, therefore creating a separate proton-rich vortex within each of the plurality of tanks 104\108\112. These pre-configured magnetic fields can be adjusted applied by the recirculators can be auto-adjusting. Further, if the right levels of intermediate fluids 104f\108f are occurring, the magnetic fields can be shut off entirely.

The specific magnetic field applied may vary according to characteristics of the input fluid 101. A key factor is that heterolysis (FIG. 2) occurs and breaks the covalent bonds in the water-portions of the input fluid. Subjecting the input fluid 101 to a magnetic field provides a low-cost non-CO₂-creating way of doing this.

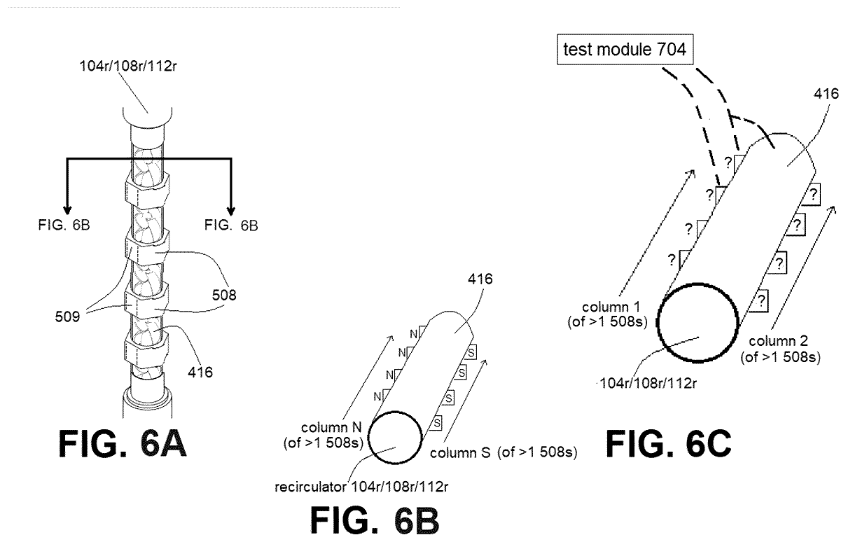

FIGS. 6A-6C show example recirculators 104r/108r/112r and FIG. 6C shows a testing module 704 that can affect production of the PRIF 140 in real-time. Under the right circumstances, the inductors of FIG. 6C can be re-oriented in a variety of patterns and polarities, hence the question-marks of FIG. 6C. The recirculator of FIG. 6C is patterned to look similar to FIG. 6B, which shows static magnets with known fixed polarities, but that is for illustration-only and the embodiments herein should not be considered as limited exclusively thereto. Instead, FIG. 6C should be interpreted to borrow from the example of FIG. 6B, but expand it to show a variety of configurations and adjustable features including not being committed to a specific polarity. The embodiment of FIG. 6C shows a test module 704 and columns of magnetic modules 508 that can be changed depending on feedback from the test module.

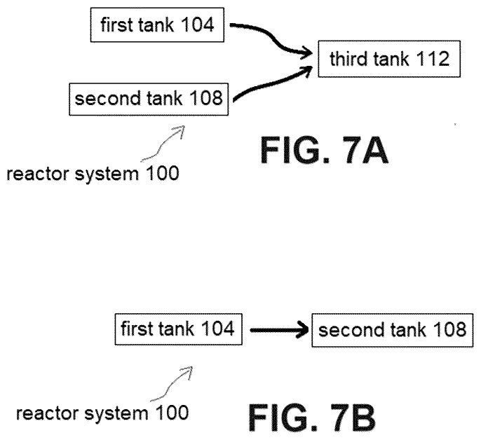

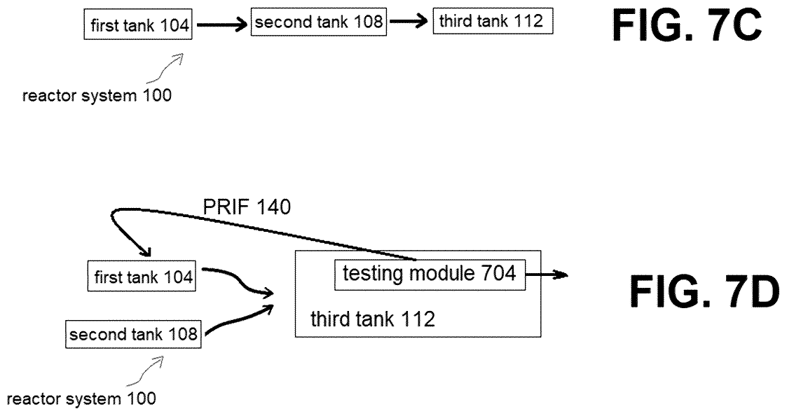

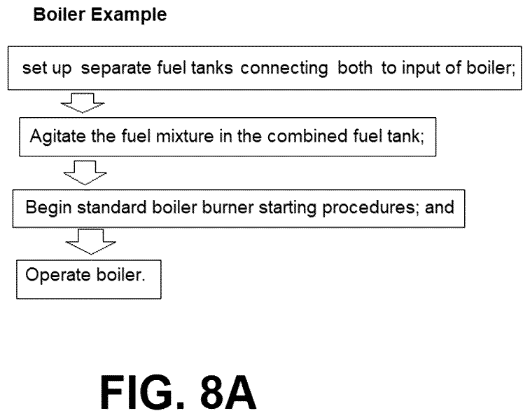

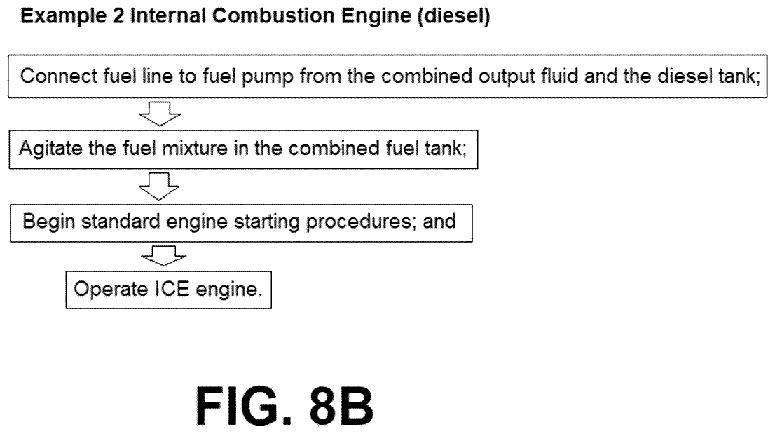

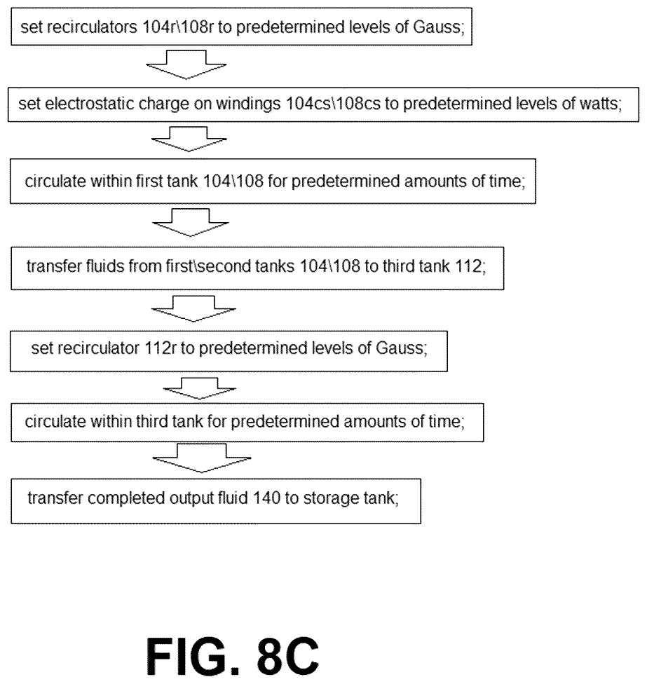

The testing module 704 of FIGS. 6C and FIG. 7D can sense breaking of covalent bonds, other factors, and can adjust magnetic or electromagnetic fields and polarities in order to achieve a desired content of PRIF 140.

The testing module 704 can comprise a mass gas analyzer, ammonia or peroxide analyzers, and potentially API testing. API testing can include high-resolution mass spectrometry, liquid chromatography, high-performance thin-layer chromatography (HPTLC), and stability testing.

FIGS. 7A-7B-7C show contrasting arrangements in which potential alternate embodiments of the system 100 can include a 2-tank rather than 3-tank system 100. FIG. 7D shows another alternative routing within the system 100 including the testing module 704 that may optionally make decisions on sending fluid back to earlier tanks for further processing.

### Fake Green Hydrogen

The expression “Fake green hydrogen” refers to a situation where a company or entity claims to be producing “green hydrogen” meaning where the process seemingly requires minimal energy and gives off minimal CO₂, but is actually generating CO₂ through e.g. fossil fuels. This is essentially misleading consumers about the true sustainability of their product and also the amount of CO₂ given off. Another similar expression is “greenwashing” of hydrogen production.

Companies sometimes label hydrogen produced from fossil fuels as “green” to appear more environmentally friendly, to gain tax advantages, and to not reveal the amount of CO2 given off.

It can be difficult to confirm whether a company is truly producing green hydrogen as advertised. Most hydrogen is produced in the form of H2 gas that is produced by electrolysis. Certification entities are sometimes employed to provide verification and assurance that the company is using verifiable renewable energy sources to power their electrolysis process.

In sharp contrast, when using the PRIF 140, there is no electrolysis. Second, there is no CO₂ given off. The various CO₂ monitors 150 shown in e.g. FIG. 1B would affirm that. Further, the PRIF 140 is single H₁+ not H2 gas, thus does not require cracking the H2 gas.

There exists another factor in affirming authentic green Hydrogen, meaning truly green and not “astroturf” or artificially green. This factor involves proving out that the H2 gas was not even partially derived from either SMR or Haber Bosch processes, as these both produce huge amounts of CO2. This is also sometimes referred to as “greenwashing”. In order to seem more green, some entities hide their base-origins and hide the amount of coal burned to produce the hydrogen.

### CO2 Measurements

To address this, the system 100 features CO2 sensors 150 embedded at numerous locations within the system 100.

It is difficult to accurately measure gas contaminants. However, a single analyzer 150 for multiple natural gas contaminants can achieve accurate and reliable measurement. If necessary, the tanks can use the seal 141 to have an accurate inventory of everything given off within that specific tank. Further, the test data can be transferred in a tamper-proof way that cannot be overwritten, which is helpful for affirming authentic green hydrogen. The gas analyzer 150 is introduced mainly for CO2 detection, but can be used for many other purposes as well, e.g. oxygen detection.

### Additional Authentic Green Components

In an embodiment, the hydrogen-donating input fluid 101 may be sulfuric acid (H₂SO₄), although it could be any of the fluids discussed in APPENDIX A. Using an example of H₂SO₄, an important factor to note is that use of H₂SO₄ does not consume much energy, gives off a lot of heat, and does not produce CO₂. The energy required in producing one mole of sulfuric acid through the industrial “contact process” is approximately 297 kJ from the initial combustion of sulfur to sulfur dioxide, with additional energy needed for the oxidation of sulfur dioxide to sulfur trioxide and the subsequent reaction with water to form sulfuric acid. These processes all generate heat.

Specifically, to form H₂SO₄, sulfur is burned in air to produce sulfur dioxide (SO₂), which is then oxidized to sulfur trioxide (SO₃) using a catalyst, and finally reacts with water to form sulfuric acid (H₂SO₄). Production of sulfuric acid thus gives off energy, does not consume it. This provides further support that the system 100 is not “greenwashing”, i.e. hiding or mis-reporting a key process that consumes a lot of energy or gives off a lot of CO₂.

### Integration with Vaporizer 800

It is conventional to use Steam Methane Reformer (SMR) machines to act as a “cracker” for separating natural gas (CH4) to yield hydrogen gas (H2). One non-limiting example of an industry using crackers is oil refining. Many oil refineries have an SMR which takes hydrogen out of natural gas, which is useful in a hydrogen demand system. Refineries might also use a standard electrolysis unit which breaks covalent bonds.

The combination of reactor system 100 and vaporizer 800 may be introduced into such a traditional cracker arrangement to substitute for an SMR machine. The embodiments may remove the need for an SMR machines, but also may remove the need for an electrolysis unit. Using the embodiments herein, it becomes possible to locate an exemplary vaporizer 800 downstream from a conventional SMR.

Now further imagine introducing the proton-rich electron-deficient PRIF 140 into this SMR scenario. While the PRIF 140 cannot go directly into a tube trailer or cryogenic system, the PRIF 140 could be run through a vaporizer 800, dried, compressed and then made compatible within common usages such as a tube trailer, a cylinder or cryogenic system, at any pressure needed by a customer.

### Practical Usages of PRIF 140

This section discusses various usages of the Proton-Rich Ionic Fluid (PRIF) 140 in a (mainly) steady-state liquid-only format, and will have 5 separate sections.
1) AMMONIA MANUFACTURING WITHOUT HABER-BOSCH;
2) CRUDE OIL IMPROVEMENT (API LIFT);
3) MOLECULAR ENHANCEMENT OF HYDROCARBON;
4) DESULFURIZATION (distillate upgrade); and
5) Details common to all 4 above.

### 1) Ammonia Manufacturing without Haber-Bosch

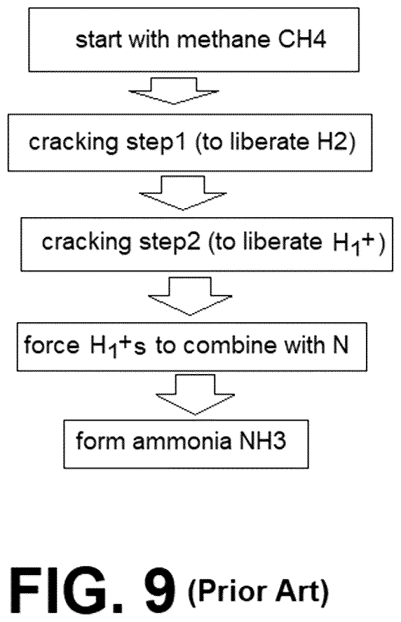

Feeding a population requires energy to make agriculture possible and ammonia (NH₃) is critical to agriculture. A current ammonia manufacturing process may utilize the Haber-Bosch method which involves taking hydrogen from Steam Methane Reforming (SMR). SMR includes cracking (separating) of hydrogen from natural gas. One takes the hydrogen H2 from SMR, take nitrogen from air, and ram it through a Haber-Bosch catalyst process to obtain H2. Various portions of this Prior Art process are shown in FIG. 9.

To make ammonia using H2, combine H2 with nitrogen gas (N2) where the hydrogen reacts with nitrogen in the presence of a catalyst to produce ammonia (NH3). This is commonly known as Haber-Bosch and the balanced chemical equation is: N2+3H2→2NH3. The Nitrogen gas comes from ambient air and hydrogen gas (H2).

An SMR process involves reacting methane (natural gas) with steam to produce hydrogen (in the form of H2) and CO2. The H2 presence is desired, but the CO2 is unwanted. SMR typically results in CO2 emissions of around 8-10 kg CO2 per kg of hydrogen produced.

Unfortunately, the Haber-Bosch process still must then re-break the H2 to make it ammonia-friendly. Further, both SMR and separately Haber-Bosch both give off a lot of CO2. Haber-Bosch thus has a duplicative process and is inefficient. Unfortunately, there seems to be no way to avoid re-breaking the H2, so that Haber-Bosch is a standard technique for making ammonia, including the unfortunate but widely accepted trade-off of large energy consumption and CO2 output. Haber-Bosch also requires a catalyst e.g. iron.

Haber-Bosch process typically requires high temperatures (around 400-500° C.) and pressures (200-400 atmospheres) to produce ammonia. Haber-Bosch accounts for 1.4% of global carbon dioxide emissions and consumes 1% of the world's total energy production. Meanwhile, the system 100 achieves hydrogen production without Haber Bosch. Fortunately, the PRIF 140 has no taint of Haber Bosch anywhere in its background.

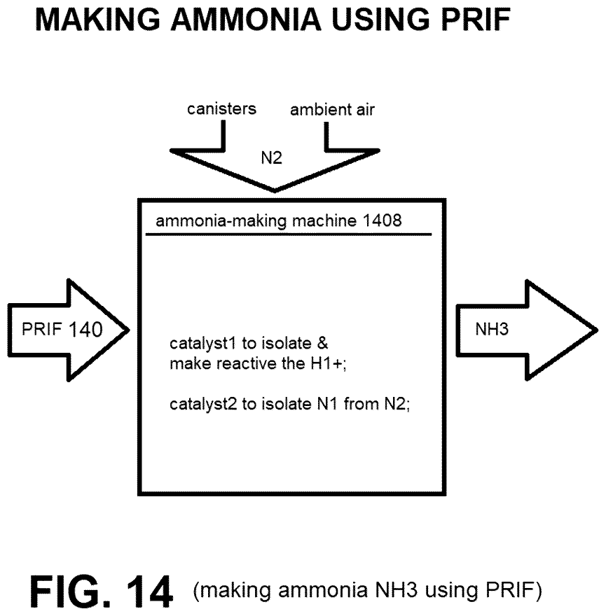

In contrast with Haber Bosch, one can instead take the single hydrogen H₁+protons (free and available to bond) that are already available in PRIF 140 and mixing all these free protons directly with ambient nitrogen, as shown in FIG. 14. One advantage of working with the PRIF 140 is that the single hydrogen protons (sometimes referred to as free protons, or H₁+) are readily available with no cracking needed. One can mix these available H₁+ (plural) directly with the ambient nitrogen in the air without using Haber-Bosch process. Using the PRIF 140, one need not “crack” (verb) a base feedstock e.g. natural gas to make the hydrogen available. With the PRIF 140, hydrogen is already available. That is, free protons are readily available due to the nature of the PRIF 140.

The embodiments herein make manufacturing ammonia into an energy-positive process with zero-cracking, compared to an amount of energy necessary to create ammonia by double-cracking the raw materials.

Achieving ammonia manufacturing without Haber-Bosch is significant. Re-breaking (re-cracking) H2 to convert it into atomic hydrogen entails two breaks. One initial break might be prying H2 off from natural gas (CH4) using e.g. SMR. This H2 then has to be re-broken into a usable form of atomic single-hydrogen that can be forced into an ammonia (NH3) molecule. This forcing cannot easily be done on H2, because H2 is already neutral thus nonreactive. That means another cracking step.

Meanwhile, in sharp contrast, the proton-rich ionic fluid (PRIF) 140 exists in a stable complete liquid state, stable at STP/NTP, not in the format of H2 but instead H₁+, a bunch of them together, suspended in a stable liquid and suitable for transport. Since the proton-rich ionic fluid 140 is atomic hydrogen 97% by mass, it has already been cracked and isolated. So the liquid phase of PRIF 140 is already reactive.

FIG. 14 shows an example NH3 manufacturing process. Separating N2 into N1 may require a catalyst, an N-catalyst, but this would not be considered cracking. Similarly, making the free protons H₁+ into a state amenable for tri-merging with N1 may also require a catalyst, an H-catalyst, but again this would not be considered cracking either.

Thus, when mixed with nitrogen, the proton-rich ionic fluid 140 is available to react, no prepping needed. This allows reducing an amount of catalyst (e.g. iron) far below that used in Haber-Bosch. Maybe even require zero catalyst because the affinity for the nitrogen and hydrogen to bond will be greater than their affinity for remaining in their existing states.

Another important part about manufacturing ammonia without Haber Bosch is energy savings. Removing a necessity to crack H2 reduces the amount of energy needed to manufacture ammonia. A majority of costs in ammonia manufacturing are directly proportional to the amount of energy required to crack the raw materials. Next is the cost of catalysts (e.g. iron). Using the PRIF 140 reduces such need for catalysts, so this in turn also reduces overall cost of ammonia, reduces energy costs, and also reduces CO2 emissions.

The advantages are not just energy savings, but also catalyst costs and equipment costs. Operation and Maintenance (OM) costs go down dramatically. The second most expensive cost to any catalytic reaction is the actual catalyst, because a catalyst dwindles as it's reacted upon. The embodiments herein facilitate a minimal-catalyst & potentially catalyst-free ammonia manufacturing process, achieving overall cost savings and service savings.

In closing this section 1), ammonia is 5% of the world's energy. The world needs ammonia. But ammonia should not be formed strictly by electrolysis. The energy costs are too high. Meanwhile, the PRIF 140 has no electrolysis anywhere in its formation. The ammonia formed by the embodiments herein is indistinguishable from ammonia formed some other conventional way, but with hugely less energy lost. NH3 is NH3, however it got there.

### 2) Crude Oil Improvement (Api Lift)

The expression “API lift” is associated with improving crude oil. API stands for American Petroleum Institute, which provides numeric ratings for various types of crude oil, as shown below.
Extra-heavy crude: <15 API
Heavy crude: 15-22 API
Medium crude: 22-32 API
Light crude: 32-42 API
Ultra-light: 42-52 API
Condensate: >52 API

When beginning a fracking process in e.g. an oil well formation, the early crude extracted may start at a 32 to 36 API. But as the oil well formation begins to deplete, an API of the remaining formation may go down to 28 or 30 API. API is directly proportional to how much percentage of distillate (good useful burnable energy-producing portion) obtained per barrel.

The lower the API, the less percentage of high quality distillates that come out of that barrel. The embodiments herein provide a low-cost low-CO2 way to lift that API.

A known problem is that refineries are configured to only accept crude oil that is within a set API range, give or take 2 or 3. As a well-formation begins to deplete and become lesser quality, a refinery must either increase the amount of hydrogen used from a cracker, literally, or stop drilling and go to another oil well formation. There's no middle ground. Any refinery's API expectations cannot be changed without major expense. The PRIF 140 provides that middle ground due to its capacity for API lift.

Accordingly, one purchaser of the PRIF 140 herein might be refineries, because refineries would be forced to use a hydrocracker to ensure that their output is matched to the proper API it was built for. This is costly. Refineries are built for a set API, difficult to adjust, so purchasers of PRIF 140 could be refiners but may also be operators of a mine, zone, or site. Some companies like Exxon and BP have the luxury of having their own refineries. Meanwhile, a smaller company from e.g. Mexico may ship their product out for refining and they get penalized aggressively. This is because most refineries have to upgrade (API lift) crude from that smaller company FF because of its lower quality.

Molecular enhancement of hydrocarbons (MEH) is discussed in more detail elsewhere (section 3) of this disclosure, but is still relevant here because of the similarity. MEH involves taking long chain hydrocarbons and cracking them to create shorter chains. Doing so could take an API of crude from 18-20 and lift it to 25-30. The higher the API, the higher the percentage of distillate refine it occurs. Shorter molecular chains means there are more hydrocarbons available for combustion meaning a change in API. Thus, MEH and API lift are related.

Each refinery is designed to work with an explicit API range. Therefore, if a drilling zone begins to fall below the refined need, one must either crack it, enhance it, or stop drilling that formation and go to a new formation. So, enhancing the API has twofold advantages. A life-span of an oil well formation can be enhanced, while refinery efficiency and expense-reduction is also maintained.

Refiners would thus be one potential purchaser of API lift using the PRIF 140. Instead of having the capital costs of changing all the refinery guts, one can just increase the API (AKA “crack spread”) thereby operating a refinery at the efficiency it was originally configured for.

### Low-Cost Tabletop Demonstration of Api Lift

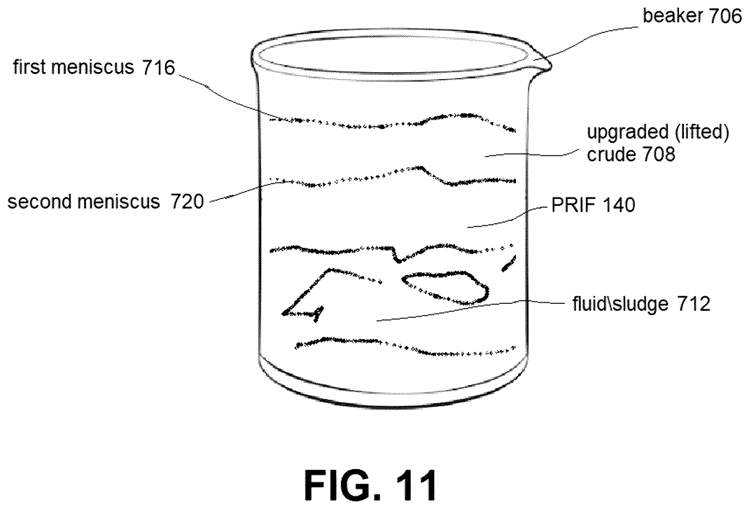

It can be difficult to convince key purchasers that the methods and principles herein actually work. The energy industry is mature, knowledgeable and can be slow or skeptical to accept change. In closing this section 2) on API lift, FIG. 11 shows an example method of testing\affirming the PRIF 140 causing noticeable API lift in a crude sample, using very small amounts. This testing method can be done quickly with minimal equipment, minimal oil, and minimal PRIF 140.

FIG. 11 shows an end-result of such a test of API lift for a mall sample. From FIG. 11 it is apparent that an example sample viewable by a lay-person that can be contained in a typical hand-held chemical beaker. This end-result is shown at the beginning of the explanation, so that any reader can see the intention right away.

To perform the small-scale tabletop affirmation of API lift, the following equipment can be helpful: heated stir plate with stir bar; graduated glass beaker; two liquid sample bottles with closure, graduated glass pipette (or Auto-pipette); graduated 50 ml glass pipette; two 47 mm anodized aluminum clamps; thermometer; variable DC power supply with alligator leads; and two graphite electrodes.

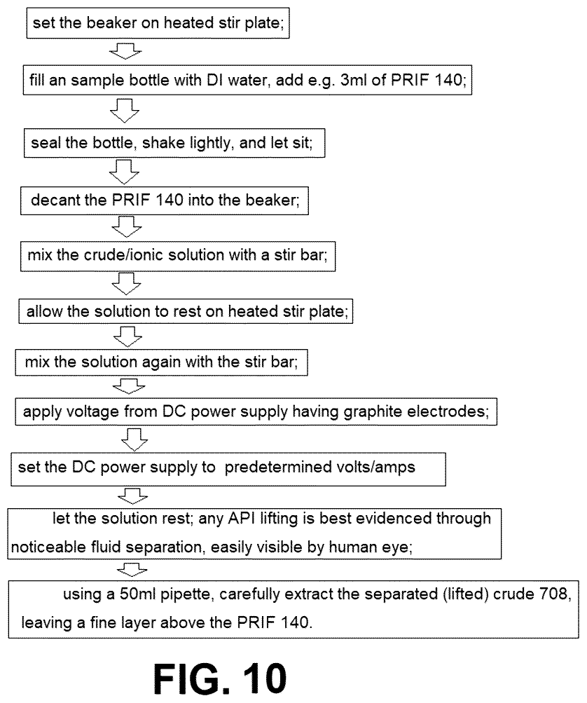

Once the above equipment is affirmed, there are 7 main steps to assessing API lift, as shown in FIG. 10 API-flow.

### 1. Sample Preparation:

Collect a predetermined amount e.g. 50ml of crude oil and place it into a 100 ml glass beaker 706;
Set the beaker on a heated stir plate and bring the temperature to 38° C.

### 2. PRIF 140 Preparation:

Fill a sample bottle with 2 ml of deionized water then add 3 ml of PRIF 140;
Seal the bottle, shake lightly, and let it sit for 10 seconds.

### 3. Mixing:

Decant the 5ml ionic solution into the beaker 706 containing e.g. 50ml of crude oil;
Mix the crude/ionic solution with a stir bar for 5 minutes.

### 4. Resting:

Allow the solution to rest on the heated stir plate at 38° C. for e.g. 20 minutes;
Mix the solution again with the stir bar for 5 minutes.

### 5. Electrochemical Treatment:

Apply a low voltage using a DC power supply with graphite electrodes;
Set the power supply to 11 volts and 5 AMPs, applying the voltage for 2 minutes.

### 6. Post-Treatment Resting:

Turn off the power supply and let the solution rest for 30 minutes. For baseline tests, allow the product to rest for 24 hours or longer if micro-bubbles are observed. The reason for this delay is that the API lifting takes a while, maybe a full day. Also, any API lifting is best evidenced by noticeable fluid separation, easily visible by the human eye. The time to complete may vary, but the eventual separation will not. One can use a naked eye to determine completion.

### p 7. Separation:

As shown in FIG. 11, after enough time, there should emerge three separate fluid levels. The highest fluid will be the “lifted” crude oil 708, where highest refers to both height, and also to API rating. Below the lifted crude oil 708 will be the PRIF 140. Below that will be a fluid/sludge 712 (e.g. ash, sulfur, irons, carbonates, random precipitates) comprising some quasi-solids, e.g. removed sulfur in a semi-solid form that has been left behind after lifting.

Using a 50 ml pipette, one can carefully extract the separated (lifted) crude 708, leaving a fine layer above the PRIF 140. It is necessary to be delicate, and avoid disturbing or agitating the beaker 706, partly to avoid re-mixing any of the three fluids.

The above steps can be helpful in affirming any API lift obtained from combining crude with the PRIF 140, and can be done in conventional settings without a lot of complex equipment.

Finally, the API lift testing in FIG. 11 is intentionally depicted in a small sale, using small amounts, easily grasped (both literally and figuratively), and thus quickly makes the point. Fortunately, this test “scales” well, in that the same principles apply even if performing at larger sizes e.g. 55 gal barrel, container load, rail car, shipping tanker, or other widely used modality widely used within the energy industry.

### 3) Molecular Enhancement of Hydrocarbon

As stated earlier, molecular enhancement of hydrocarbons (MEH) is taking long molecular chains, cracking them, and creating shorter chains. In doing so, taking an API of oil e.g. 18 or 20, lift that API to e.g. 24. MEH combines both crude improvement and distillate improvement, because they're both hydrocarbon-based and both help improve refinery efficiency.

MEH is similar to an API lift, but in somewhat different form. During refining, a barrel of crude may be put through a distillation column. Oil, gas, jet fuel, diesel, kerosene, gasoline, bunker fuel, are all distillates of crude, and all contain hydrocarbons, where hydrocarbons are the “money” component.

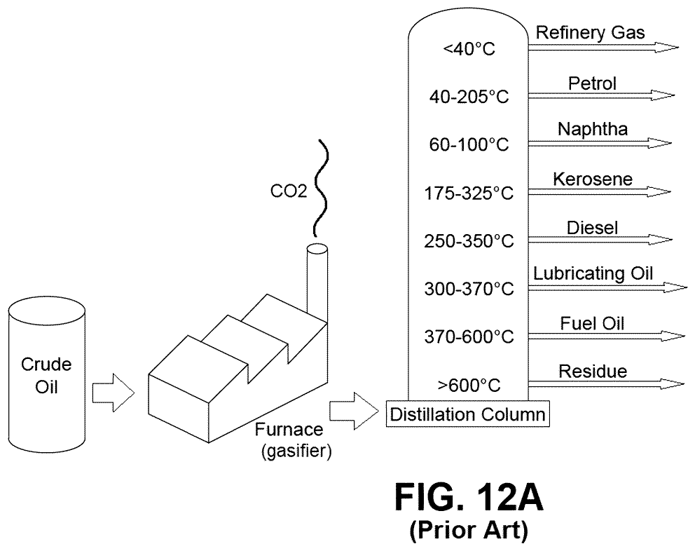

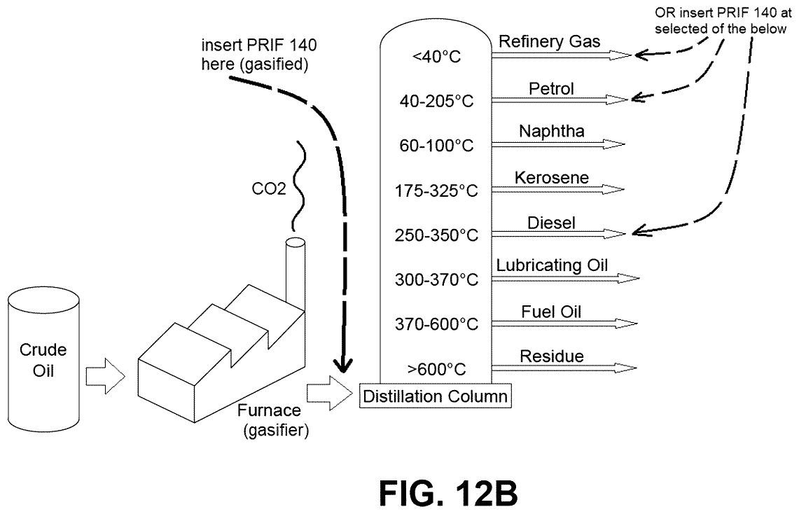

Proper use of PRIF 140 can get to almost double current molecular enhancement of hydrocarbons. Either for crude improvement (e.g. going through a hydrocracker) OR for distillate upgrade (e.g. going through a distillation column e.g. FIG. 12).

FIG. 12 shows a conventional distillation column as is well-known in the art, but in a flowchart format. The heating and distilling of the incoming crude oil all consumes a lot of energy, and also gives off a lot of CO2. In the flowchart of FIG. 12, all activity flows from left to right. As shown in FIG. 12, a distillation column takes common hydrogen (in H2 format), breaks it apart into atomic hydrogen and outputs it into a crude or distillate gas stream.

This combining the PRIF with a distribution column then takes long chain hydrocarbons and shrinks them to shorter chain hydrocarbons according to the scale shown in FIG. 12. Since the proton-rich ionic fluid 140 is already mono-atomic in its liquid state, it can go directly into liquid crudes and or liquid distillates of various entry points (see FIG. 12) and achieve upgrading from the donation of its H₁+ thereby achieving breakage of long chain hydrocarbons.

Meanwhile, the PRIF 140 already arrives with pre-stabilized atomic hydrogen (with the sole electron removed) in the form H₁+ (not H2). This means that doing MEH using PRIF 140 has a lower energy cost and less moving parts, because there is no cracker or de-sulfurization involved. A cracker eats up big energy consumption. De-sulfurization will be addressed in a following section.

Next, as already stated, this entire disclosure strives to show practical usages, applications, and potential end customers for the various PRIF 140 usages where possible. All refineries are built a certain way, and not easily adjusted after-the-fact. As their formations age, their API goes down or the weight of the oil gets heavier. When it gets heavier it gets lower quality. Thus refineries could be purchasers of the MEH techniques described herein. In closing section 3), an aging refinery would quickly see the benefits of using the proton-rich ionic fluid 140 for MEH.

### 4) Distillate Upgrade (De-Sulphurization)

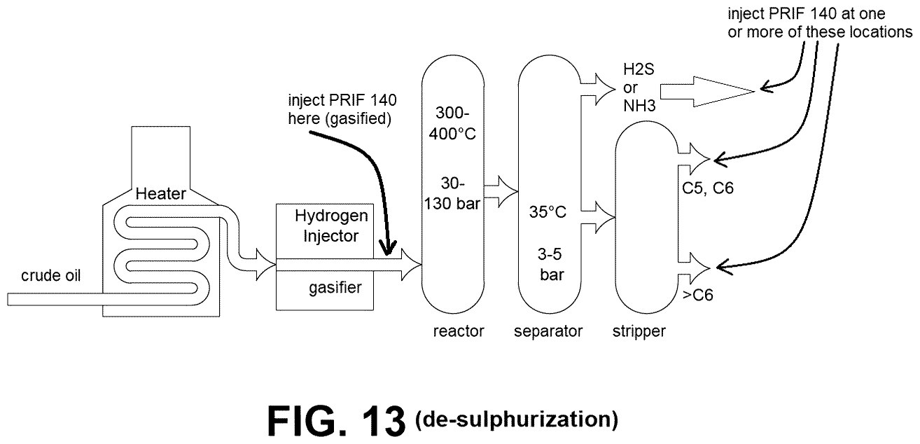

This 4^{th} method uses the embodiments in both FIG. 13, and sometimes portions of FIG. 12B. FIG. 13 shows an example de-sulphurization stack, intentionally simplified for clarity. Hydrodesulfurization (HDS) is effective at removing sulfur from fuels and significantly reducing sulfur dioxide emissions, but contributes to CO₂ emissions. As shown in FIG. 13, HDS requires high temperatures and pressures, often leading to increased hydrogen consumption and consequently higher CO₂ production. This makes a trade-off between cleaner fuel and higher CO₂ footprint. The high temperatures and pressures also entail increased energy to operate. If this energy was produced by burning coal, that is another source of CO₂.

HDS relies on hydrogen to remove sulfur, and producing hydrogen itself can generate CO₂ if sourced from fossil fuels. Periodic replacement of the catalyst used in HDS also contributes to CO₂ emissions due to the energy needed for the regeneration process.

As a specific formation gets used up, the crude therein becomes lesser quality (e.g. more sour) in that particular mine-formation. The fluid pumped out of that well becomes sour (sulfur). As crude sours, its average amount of sulfur is greater than 0.6% by mass of the total barrel. The sulfur content in the barrel unfortunately transfers into the oil distillates. The number one oil distillate that everyone talks about is diesel fuel. Diesel must have a sulfur content less than 15 PPM in the United States, and less than 10 PPM in the in EU. Otherwise it cannot be sold to consumers.

Getting rid of sulfur is not easy. As shown in FIG. 13, an HDS process consumes huge amounts of energy, gives off CO2 and has other problems. The PRIF 140 carefully steps around these well-established problems in a novel and innovative way.

It is an important principle of the embodiments herein to be usable and helpful in newly built mechanisms for developing hydrogen, but also to be compatible with existing energy infrastructures. Thus, FIG. 13 shows a conventional desulfurization mechanism, but in a flowchart format. Specifically, the desulfurization mechanism of FIG. 13 has a reactor, separator, and stripper, as is well-known in the art but where all activity flows from left to right.

The heating, reacting, separating, and stripping of the incoming crude oil all consume a lot of energy, and also gives off a lot of CO2. Nonetheless, the owners of the embodiments herein are not so unrealistic as to expect refineries to completely change their infrastructure right away. Instead, adding the PRIF 140 at one or more of a variety of existing locations can reduce the amount of energy consumed, reduce an amount of CO2 given off, and decrease the time necessary to achieve a usable sellable version of oil that has been de-sulfurized. An added benefit is that using the structure of FIG. 13 may potentially also achieve an API lift on the resulting product.

API enhancement indirectly helps desulphurization, but if the oil is extremely sour, one must still run a distillation column (stack) device (e.g. FIG. 12) suitable for performing hydro-desulfurization. A conventional way to achieve this involves reboiling the distillates and running them through a molecular sieve e.g. a hydrogen blanket. The hydrogen blanket has an affinity for grabbing off the sulfur where the sulfur is either removed as H2S (dangerous), or precipitates as a solid sulfur sludge.

The embodiments herein avoid this problem in that using PRIF 140 liquid for distillate upgrade avoids any blowoff of SO2 or H2S. Sulfur dioxide gas SO2 is not so bad, tolerable, but H2S is super poisonous. Meanwhile, when using the PRIF 140 to help make a distillate, no gas-off occurs. Instead, all the unwanted elements fall out in a precipitate to the bottom of the distillation column (stack) (FIG. 12). As suggested within FIG. 1B, these solids can be removed and placed in some type of disposal 170, and/or a disposal well where they cannot harm anyone. This reduces H2S emission 100%. So, using the proton-rich ionic fluid 100 is clearly safer than using a hydrogen blanket which can result in blowoff.

One definition of sour crude is where the overall crude has greater than 0.6% sulfur. Other definitions use 0.7%. Even with aggressive API lift, there may still be sulfur in that oil distillate. And because of federal mandates, all oil distillates are sorted by sulfur content. Accordingly, using the PRIF 140 one can create an ultra-low sulfur diesel by removing the sulfur to be e.g. <15 PPM in USA, or <10 PPM in the EU.

In the past, without the PRIF 140, if hydrogen is extremely expensive, a refiner might actually not do any upgrade, as doing so would not be cost-effective. Also the hydrogen used would likely not be authentically green. But that means the diesel fuel produced by that refiner is not considered ultra-low sulfur, a disadvantage. However, using PRIF 140, the ultra-low sulfur classification is easier to achieve. Also, the hydrogen used is authentic green. Therefore the value is not only in the reduction of sulfur, but also in obtaining renewable energy credits and LCFS (Low Carbon Fuel Standards) credits. This is because upgrading the diesel fuel with authentic green hydrogen is valuable in the marketplace. There exist a lot of green hydrogen scams that mask or obscure their true nature, and are not actually green. The usages of the PRIF 140 described herein do not suffer from this problem.

### Information Common to Ammponia, Api Lift, Meh, and Desulfurization

There are at least three position models in the oil-drilling business. These include upstream (AKA downhole AKA at-formation), downstream (on-location at refinery), and midstream. Refineries typically work with downstream sources, where they take the crude and refine it.

However, API enhancement (AKA “API lift”) can also occur happen in upstream (AKA downhole) inside the drilling of the formation. It can happen two ways in a brand new oil well formation. One way is to add PRIF 140 as a substitute for water to reduce the sulfur damage that has already been done in the formation. Another way is to go into old formations, which have lost its downhole pressure and do something called EOR (Enhanced Oil Recovery). But EOR typically must be externally-pressurized with CO2 or with water flooding.

One can avoid this and instead apply water downhole with PRIF 140, so no need for external pressurization. Meanwhile, active downhole locations have already-existing pressure and temperature conditions that are suitable. Thus, using the PRIF 140 one can upgrade the formation with its natural temperatures and pressures that happen at 10,000 feet below ground.

In doing an API lift of a barrel of crude there are several steps, of which the below is a non-limiting summary.

Add PRIF 140 to crude in a proportion of 2-5% PRIF 140 by weight to the oil barrel and agitate;
apply voltage between 0.01-10 volts and 1-100 amps using an AC or DC or DC modulated power for a predetermined time period;
stop agitating, allow combination to settle;

As shown in FIG. 11, crude and PRIF 140 naturally separate, where upgraded crude is on top and PRIF 140 is at bottom. Meanwhile, sulfur contaminants 712 will be below the separated PRIF 100. Remove any excess water. It may be possible to recover some PRIF 140.

Putting the PRIF 140 directly into-downhole formations still yields an API lift, but less. This is because downhole, it's not possible to apply electrical power.

The steps would be:
inject PRIF 140 downhole at designed percentage based on characteristics of the oil well formation, where a formation with a lower API requires a higher percentage of the PRIF 140;
a downhole formation naturally agitates itself due to 1000-11,000 psi of downhole pressures;
application of electrical power downhole is not possible, but its well-known that temperature is directly proportional to downhole depth. A downhole temperature can range from 250-450 degrees F. and even higher in offshore or other formations. Accordingly, less energy will be required to separate the produced water emitted from down hole because PRIF 140 naturally facilitates some de-emulsification;
some PRIF 140 stays behind, so if feasible, try to recover that PRIF 140;
below the PRIF 140 is the sludge/solids 712, dehydrate or filter these out and potentially reused. Further, transport the sludge 712 to disposal wells if feasible.

Another advantage of the PRIF 140: “a little goes a long way”. That is, the amount of proton-rich ionic fluid 140 needed to be effective is manageable. A common rail car can carry around 35,000 gallons of PRIF 140. One can send it using unit trains, which is a hundred rail cars on average thus almost e.g. 3.5 million gallons. The common dosing level is between 24 and 60 ounces of PRIF 140 per barrel of crude. So the overall magnitude of how much liquid PRIF 140 needed for API lift is manageable.

All mining formations and refineries have some type of water nearby, but it could be in awful shape, so the owners experiment to find a suitable water-blend percentage to assist with an API lift. Using the proton-rich ionic fluid 100 reduces such experimentation, one can suggest “don't blend at all, instead use PRIF 140 as-is”.

Finally, a refinery or the driller or the EOR team could still provide their own water, including produced water. The advantage of that is they wouldn't have to clean up that water because the PRIF 140 would naturally clean the water, including produced water which is generally considered unusable for anything and must be stored in a retention pond. The embodiments herein can reduce need for dangerous, leaching retention ponds.

### DISCLAIMER

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

### APPENDIX A: EXAMPLE HYDROGEN-DONATING INPUT FLUIDS 101

A non-limiting list of potential types of hydrogen-donating fluids can include but is not limited to e.g., HCl—hydrochloric acid, HNO3—nitric acid, H2SO4—sulfuric acid, HBr—hydrobromic acid, HI—hydroiodic acid, HClO4—perchloric acid, HClO3—chloric acid, HO2C2O22H—oxalic acid, H2SO3—sulfurous acid, H2O-water, HSO4—hydrogen sulfate ion, H3PO4—phosphoric acid, HNO2—nitrous acid, HF—hydrofluoric acid, HCO2H—methanoic acid, C6H5COOH—benzoic acid, CH3COOH—acetic acid, HCOOH—formic acid, C6H8O7—citric acid, C18H36O2—stearic acid, CH3OH—methyl alcohol, CH3CH2OH—ethyl alcohol, CH3 (CH2) 3OH—n-butyl alcohol, C3H8O—propanol, CH3CH2CH2OH—n-propyl alcohol, (CH3) 3COH—t-butyl alcohol, CH3 (CH2)4OH—n-pentyl alcohol, and (CH3) 2CHOH—isopropyl alcohol.

What is claimed is:

1. A method of producing a Proton-Rich lonic Fluid (PRIF), comprising:
configuring a first tank for receiving and circulating a hydrogen-donating input fluid;
arranging a first recirculator and first pump into fluid communication with the first tank and circulating the input fluid within a first enclosed zone for a first predetermined duration;
the first recirculator and first pump breaking the covalent bonds of water into oxygen and hydrogen and removing the freed oxygen and leaving behind a plurality of H₁+ protons;
outputting a first intermediate fluid to a third tank;
configuring a second tank for receiving the hydrogen-donating input fluid;
arranging a second recirculator and second pump into fluid communication with the second enclosed zone;
outputting a second intermediate fluid to the third tank;
configuring a third tank for receiving and circulating processed fluid from the first and second zones;
arranging a third recirculator and third pump into fluid communication with the third enclosed zone;
forming a proton-rich ionic fluid (PRIF) having the plurality of separated H₁+ protons therein; and
outputting the completed PRIF from the third tank into a storage tank.

2. The method of claim 1, further comprising:
the enclosed zones removing electrons from the input fluid in such a way that the resulting PRIF becomes electron-deficient.

3. The method of claim 2, further comprising:
combining the PRIF with a predetermined amount of crude oil to achieve an API lift of the crude oil;
prepping the PRIF with DI water;
combining the combination into the crude;
agitating the combination;
applying voltage; and
extracting lifted crude.

4. The method of claim 2, further comprising:
combining the PRIF with a predetermined amount and API of crude oil to achieve Molecular Enhancement of Hydrocarbons (MEH) using a distillation column; and
inserting the PRIF into the distillation column in a gaseous form pre-distillation.

5. The method of claim 2, further comprising:
combining the PRIF with a predetermined amount and API of crude oil to achieve Molecular Enhancement of Hydrocarbons (MEH) using a distillation column; and
providing the PRIF after the distillation column in a liquid form post-distillation, at selected points in the distillation-gradation portions of the distillation column.

6. The method of claim 2, further comprising:
using the PRIF to produce ammonia while bypassing any Haber Bosch method of ammonia production;
obtaining a predetermined amount of N2 from ambient air;
taking the ambient air and providing an N-catalyst to separate the N2 into N1 components; and
providing an H-catalyst to isolate the H₁+ inherent within the PRIF.

7. The method of claim 2, further comprising:
using the PRIF to produce ammonia while bypassing any Haber Bosch method of ammonia production;
obtaining a predetermined amount of N1; and
providing an H-catalyst to isolate the H₁+ inherent within the PRIF.

8. The method of claim 2, further comprising:
combining the PRIF with a predetermined amount of crude oil;
de-sulfurizing the crude oil using a de-sulfurizer having a heater, gasifier, reactor, separated, and stripper;
providing PRIF at a variety of entry-points between any of heater, gasifier, reactor, separated, and stripper in either of gaseous or liquid format.

9. The method of claim 8, further comprising:
selecting the one or more entry points based on a desired outcome including sulfur levels.

10. The method of claim 8, further comprising:
selecting the one or more entry points based on ease of access to equipment within the de-sulfurizer.

11. The method of claim 2, further comprising
injecting location-specific on-site downhole injection of PRIF; and
utilizing existing downhole heat and pressure to integrate the PRIF with the downhole crude being extracted, thereby making portions of the downhole crude more accessible.

12. The method of claim 1, further comprising:
subjecting the first recirculator to a first magnetic field from a first magnetic module attached to the first recirculator;
subjecting the second recirculator to a second magnetic field from a second magnetic module;
subjecting the third recirculator to a third magnetic field using a third magnetic module attached to the third recirculator for a third predetermined time period;
configuring the magnetic modules according to predetermined criteria; and
during the production process, adjusting the magnetic modules according to pre-configured criteria so as to achieve a desired formulation of output fluid.

13. The method of claim 12, further comprising:
separately monitoring the first, second, and third tanks for temperature, CO2 production, oxygen production, and proton separation.
